(19) United States
(12) Patent Application Publication
(10) Pub. No.: US 2005/0170854 A1
(43) Pub. Date: Aug. 4, 2005

(54) Network support for multi-line mobile device

(76) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(21) Appl. No.: 10/768,646

(22) Filed: Jan. 30, 2004

(51) Int. Cl. H04Q 7/20

(52) U.S. Cl. 455/461

(57) ABSTRACT

A wireless network provides service to each line of a multi-line mobile device and includes: a mobile switching center for processing incoming and outgoing calls associated with the multi-line mobile device and a subscriber database including an independent calling plan for each line of the multi-line mobile device. Each line is associated with a unique directory number and each independent calling plan corresponds to unique directory numbers. At least two of the independent calling plans include at least one of a text messaging flag and a wireless Web flag. At least one of the text messaging flag and the wireless Web flag are activated for at least two of the independent calling plans. Various methods are also provided for a wireless network to provide wireless service to each line of multiple lines associated with a multi-line mobile device.

### BACKGROUND OF INVENTION

The invention generally relates to a wireless network with a mobile station (MS) and, more particularly, to a method for the wireless network to support wireless service to two independent numbers associated with the MS and will be described with particular reference thereto. However, it is to be appreciated that the invention is also amenable to other applications.

Mobile subscribers are becoming increasingly connected to their mobile handsets which are often viewed as a necessary accessory during waking hours. Also, the line between work life and personal life is increasingly blurred due to the workplace demands on many employees, combined with longer hours, flex-time schedules, etc. In many circumstances, mobile subscribers would like to be able to share a single mobile handset between their work and personal life, while still being able to maintain separation between the two telephone numbers, calling plans and billing arrangements. The alternatives of switching between separate work and personal handsets, or worse yet, appearing in public attached to two mobile phones, are quite unattractive.

U.S. Pat. App. Pub. No. 2002/0127999 discloses a radio communications device (RCD) which can maintain, even if different voicemails are received at a plurality of communications lines, any of prompts advising receipt of the voicemails until after retrieval of the voicemail is ended. The RCD is capable of supporting at least two communication lines and includes an indication section for indicating that messages have been received for multiple communications lines and maintaining the indication regarding any of the messages until the message is retrieved.

Alternate line service is a feature where the SIM card in a mobile device has two associated directory numbers (DNs). This allows a user to direct two DNs (i.e. two lines) to one mobile device to avoid carrying more than one device. At any time, the user can select from which line the user wishes to call and may receive an individual bill for each line. The user may set a default line for outgoing calls which the user may change as desired. A variety of existing mobile devices are compatible with alternate line service. For example, the i60c mobile phone manufactured by Motorola and available from Nextel supports alternate line service. Nextel, for example, is a wireless service provider and provides alternate line service as an option to its subscribers.

Nextel's alternate line service provides subscribers with the convenience of two phone numbers for one phone. The subscriber, for example, may use one number for business and one for personal calls or both numbers for business. Each phone number can be assigned its own ring tone. Nextel allows the subscriber to select between receiving one invoice each month for both phone numbers or separate billing. The two phone numbers can be in different area codes as long as both numbers reside in the same local market. The subscriber can set up call forwarding for both lines independently. Forwarding the second line to the primary line will send second line incoming calls directly to voice mail without ringing.

To receive alternate line service from Nextel, a subscriber sets up a rate plan for a primary line and then selects an alternate line service rate plan for the second line. Nextel's mobile messaging and wireless web services use the primary line. Subscribers only need to subscribe to caller ID or voice mail once to receive these services on both lines. Ring/vibe, in call setup, call timers, and auto answer settings are independent for both lines. When the phone receives a call on either line, regardless of the active line setting, the screen displays “Line 1” or “Line 2” to indicate which line the call is being received on. The subscriber may also set different ring tones for each line. If the subscriber has subscribed to call waiting service, call waiting will notify the subscriber of a second call regardless of which line is being used.

The two lines associated with a mobile device through alternate line service cannot be independently configured with respect to all services, features, and settings associated with the primary line and the second or alternate line. Moreover, alternate line service does not support more than two lines.

Thus, there is motivation for wireless networks to provide subscribers with a multi-line service that permits multiple independently configured lines to be associated with a mobile device. There is also motivation for the multi-line service to permit three or more lines to be associated with a mobile device.

### BRIEF SUMMARY OF INVENTION

In one aspect of the invention, a method for a wireless network to provide wireless service to each line of multiple lines associated with a multi-line mobile device is provided. A wireless service provider is associated with the wireless network and a subscriber is associated with the multi-line mobile device. The method includes: a) assigning a unique directory number to each line, wherein each unique directory number of multiple unique directory number corresponds to one line of the multiple lines associated with the multi-line mobile device, b) providing the subscriber with an independent calling plan for each line, wherein each independent calling plan of multiple independent calling plans corresponds to one unique directory number, and c) configuring each independent calling plan to include information, values, and parameters that independently control call processing and billing functions for incoming calls and outgoing calls associated with the corresponding one unique directory numbers.

In another aspect of the invention, a method for a wireless network to provide wireless service to a first line and a second line associated with a two-line mobile device is provided. A wireless service provider is associated with the wireless network and a subscriber is associated with the multi-line mobile device. The method includes: a) assigning a first unique directory number to the first line and a second unique directory number to the second line, b) providing the subscriber with a first independent calling plan for the first line and a second independent calling plan for the second line, wherein both the first and second independent calling plans include at least one of a text messaging flag for activation in conjunction with the corresponding directory number and a wireless Web flag for activation in conjunction with the corresponding directory number, and c) configuring the first and second independent calling plan to include information, values, and parameters that independently control call processing and billing functions for incoming calls and outgoing calls associated with the corresponding first and second unique directory numbers, wherein at least one of the text messaging flag and the wireless Web flag are activated for both the first and second independent calling plans.

In still another aspect of the invention, a wireless network providing wireless service to each line of multiple lines associated with a multi-line mobile device is provided. A wireless service provider is associated with the wireless network and a subscriber is associated with the multi-line mobile device. The wireless network includes: a mobile switching center for processing incoming and outgoing calls associated with each line of the multi-line mobile device, wherein each line of the multi-line mobile device is associated with a unique directory number, and a subscriber database in communication with the mobile switching center and including an independent calling plan for each line of the multi-line mobile device, wherein each independent calling plan corresponds to a unique directory number, wherein at least two of the independent calling plans include at least one of a text messaging flag for activation in conjunction with the corresponding directory number and a wireless Web flag for activation in conjunction with the corresponding directory number, wherein at least one of the text messaging flag and the wireless Web flag are activated for at least two of the independent calling plans.

Benefits and advantages of the invention will become apparent to those of ordinary skill in the art upon reading and understanding the description of the invention provided herein.

### BRIEF DESCRIPTION OF DRAWINGS

The invention is described in more detail in conjunction with a set of accompanying drawings.

FIG. 1 is a block diagram of an embodiment of a telecommunication system incorporating at least one aspect of the invention.

FIG. 2 is a diagram of an embodiment of a portion of the content of a subscriber database showing exemplary multiple calling plans associated with a multi-line mobile device and incorporating at least one aspect of the invention.

FIG. 3 is a flowchart of an embodiment of a method for processing an outgoing call from a multi-line mobile device.

FIG. 4 is a flowchart of an embodiment of a method for processing an incoming call to a multi-line mobile device.

### DETAILED DESCRIPTION

While the invention is described in conjunction with the accompanying drawings, the drawings are for purposes of illustrating exemplary embodiments of the invention and are not to be construed as limiting the invention to such embodiments. It is understood that the invention may take form in various components and arrangement of components and in various steps and arrangement of steps beyond those provided in the drawings and associated description. In the drawings, like reference numerals denote like elements and similar reference numerals denote similar elements.

In general, the invention provides wireless network support for multiple telephone numbers, each number associated with a multi-line mobile device and each number having its own independent calling plan. This includes providing a wireless network solution with the necessary support for distinct telephone numbers having independent alerting tones, independent calling plans, and independent billing arrangements.

For example, this includes: a) a methodology for the wireless network to recognize that a particular mobile device has two or more distinct telephone numbers, b) a methodology for the wireless network to recognize that a particular mobile device has a distinct and independent calling plan for each distinct telephone number, c) a methodology for the wireless network to recognize that a particular mobile device has a distinct and independent alerting tone for each distinct telephone number, d) a methodology for the wireless network to recognize that a particular mobile device has a distinct and independent billing arrangement for each distinct telephone number, e) a methodology for the wireless network to recognize that a particular mobile device has distinct and independent voice mailboxes for each distinct telephone number, f) a methodology for the wireless network to recognize that a particular mobile device can specify the calling plan to which a specific originating call should be charged, and g) a methodology for the wireless network to recognize which of the calling plans a specific terminating call should be charged.

The wireless network is aware of the multi-number capability of the mobile device by a data entry maintained in a subscriber database. Terminating calls to the mobile device are charged against the number which was dialed by the calling party. When the phone is ringing, and during the call, the charged number appears in the display of the mobile device. Also, each number may have a different alerting tone to indicate that the mobile device is currently in receipt of an incoming call. Additionally, when the mobile subscriber uses the multi-line mobile device to originate a call, the line charged can be a) specified by a special code or sequence of keys activated by the subscriber or b) default to a line previously selected as the default for outgoing call charges by the subscriber.

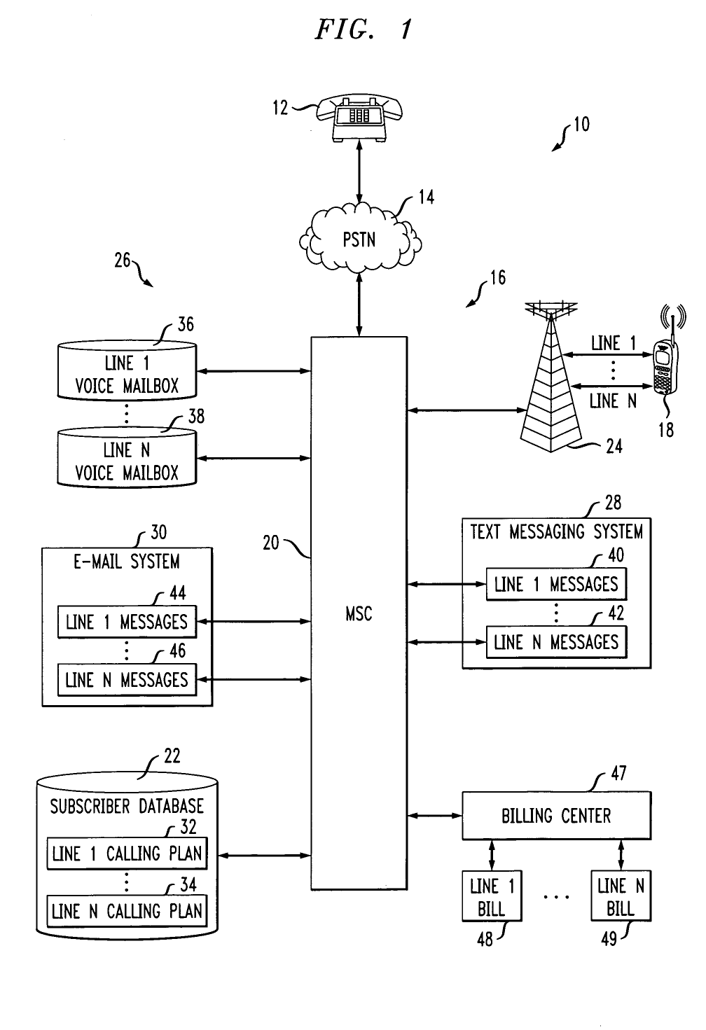

With reference to FIG. 1, a telecommunication system 10 includes a landline telephone device 12, a public switched telephone network (PSTN) 14, a wireless network 16, and a multi-line mobile device 18. The wireless network 16 includes a mobile switching center (MSC) 20, a subscriber database system 22, a base station (BS) 24, a voice mail system 26, a text messaging system 28, and an e-mail system 30. A wireless service provider provides wireless service to a subscriber associated with the multi-line mobile device 18 via the wireless network 16. The subscriber database 22 includes a line 1 calling plan 32 through a line N calling plan 34. In alternate embodiments, the subscriber database 22 may be incorporated in a home location register (HLR) associated with the MSC 20 or within the MSC 20.

The voice mail system 26 includes a line 1 voice mailbox 36 through a line N voice mailbox 38. The voice mail system 26 uses any suitable implementation of existing voice mail communication technology offered by wireless service providers. The text messaging system 28 includes a line 1 text message storage area 40 through a line N text message storage area 42. The text messaging system 28 uses any suitable implementation of existing text message communication technology, such as SMS. The e-mail system 30 includes a line 1 e-mail message storage area 44 through a line N e-mail message storage area 46. The e-mail system 30 uses any suitable implementation of existing e-mail communication technology, such as the Internet. A billing center 47 associated with the wireless network 16 is also depicted with a line 1 bill 48 through a line N bill 49. The billing center 47 uses any suitable implementation of existing communication technology and accounting algorithms used by wireless service providers.

The multi-line mobile device 18 is associated with two or more DNs (i.e., lines, telephone numbers, etc.). The wireless network 16 provides distinct and independent wireless service to each of the DNs as is reflected by the line 1 through line N calling plans 32, 34, the line 1 through line N voice mailboxes 36, 38, the line 1 through a line N text message storage areas 40, 42, the line 1 through a line N e-mail message storage areas 44, 46, and the line 1 through line N bills 48, 49. The subscriber or another user of the multi-line mobile device can distribute the multiple DNs to people for various purposes and the wireless network 16 will terminate incoming calls for each of the multiple DNs to the multi-line mobile device 18. For example, the subscriber may distribute one or more DNs for business use to certain people, one or more DNs for personal use to other people, and one or more DNs for hotlines to certain people. The one or more DNs for business use may be allocated and made available to people in any manner (e.g., geographic areas, product areas, service areas, etc.). Likewise, the one or more DNs for personal use may be allocated and made available to people in any manner (e.g., family, spouse's family, friends, neighbors, etc.). Additionally, a hotline can identified for business use and another hotline for personal use and made available to certain people in any manner.

Call processing and billing functions within the wireless network for incoming calls to any particular DN are based on information, features, values, and parameters established in the independent calling plan corresponding to that DN. As for outgoing calls, the subscriber or other user of the multi-line mobile device 18 may select a default line or manually select a particular DN for origination of a call. Call processing and billing functions within the wireless network for the outgoing call is based on information, features, values, and parameters established in the independent calling plan corresponding to the originating DN. Thus, each independent calling plan may be configured to independently control call processing and billing functions for incoming and outgoing calls associated with corresponding DNs assigned to the multiple lines associated with the multi-line mobile device 18.

As shown, the telecommunication network 10 supports scenarios for calls originating at the landline telephone device 12 to any one of the DNs associated with the multi-line mobile device 18. The telecommunication network 10 also supports scenarios for calls originating from any one of the DNs associated with the multi-line mobile device 18 to the landline telephone device 12. Of course, in alternate embodiments the landline telephone device 12 may be replaced by a mobile device and the PSTN 14 may be replaced by another wireless network. In other words, the calling leg associated with the landline telephone device 12 and PSTN 14 may be replaced by any set of devices capable of communicating with the multi-line mobile device 18 via the wireless network 16, including computer systems via the Internet.

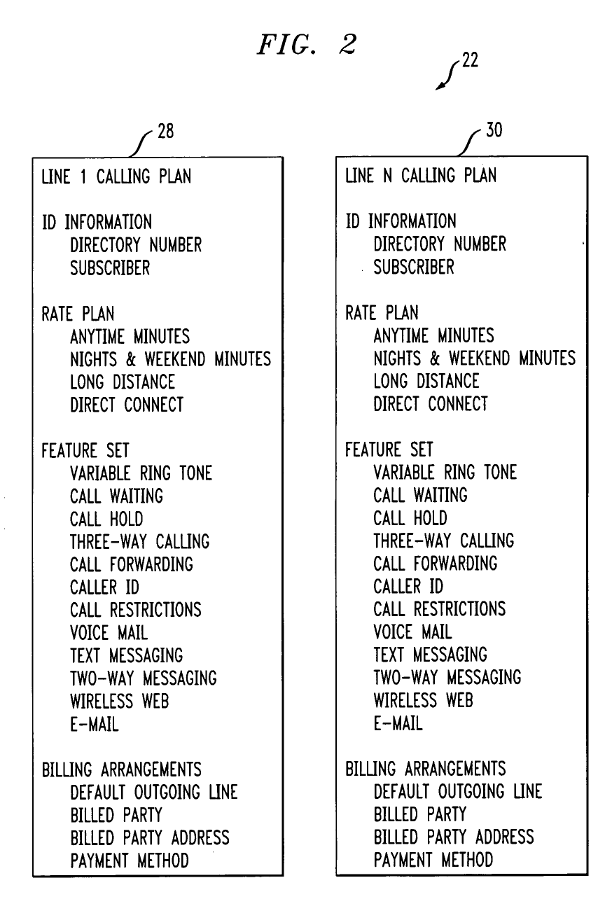

With reference to FIG. 2, the multiple calling plans corresponding to the multiple DNs associated with the multi-line mobile device 18 (FIG. 1) are shown within the subscriber database 22. The line 1 calling plan 28 may include, for example, identification information, a rate plan, a feature set, and billing arrangements selected by the subscriber for the DN associated with line 1. Likewise, the line N calling plan 30 may include, for example, identification information, a rate plan, a feature set, and billing arrangements selected by the subscriber for the DN associated with line N. This shows the independence of each calling plan with respect to the multiple DNs or lines available to the subscriber via the multi-line mobile device 18 (FIG. 1). In other embodiments, additional information and features may be included in the calling plans.

The identification information, for example, associated with each calling plan may include the corresponding DN and subscriber. This information is typically obtained when service to the subscriber is initially established by the wireless service provider. The combination of DN and subscriber information uniquely identify each calling plan in the subscriber database 22. Additional information may also be included in the identification information section of each calling plan.

The rate plan, for example, associated with each calling plan may include an amount of anytime minutes, an amount of night and weekend minutes, a flag identifying no variable charges for long distance calls, and an amount of direct connect minutes. Typically, the subscriber selects a packaged rate plan offered by the wireless service provider at a certain monthly rate. The packaged rate plan may include values for each of the rate plan parameters in the calling plan. Alternatively, or in addition to a packaged rate plan, the subscriber may selectively activate long distance service without variable charges and direct connect service and specify values for the minute parameters. Additional information and parameters may also be included in the rate plan section of each calling plan.

The feature set, for example, associated with each calling plan may include a variable ring tone flag, a call waiting flag, a call hold flag, a three-way calling flag, a call forwarding flag, a caller ID flag, a call restrictions flag, a voice mail flag, a text messaging flag, a two-way messaging flag, a wireless Web flag, and an e-mail flag. Typically, the subscriber selects a packaged feature set offered by the wireless service provider at a certain monthly rate. The packaged feature set may include values for each of the rate plan parameters in the calling plan. The packaged feature set may be associated with a packaged rate plan. Alternatively, or in addition to a packaged feature set, the subscriber may selectively activate one or more features. Additional information and parameters may also be included in the feature set section of each calling plan.

The billing arrangements, for example, associated with each calling plan may include a flag identifying the DN or line associated with the calling plan as the default DN for billing outgoing calls, a billed party, a billed party address, and a payment method. If the default flag is set in a particular calling plan, the flag is reset in other calling plans associated with the multi-line mobile device. The billed party for one or more DNs, for example, may be the subscriber. Another one or more DNs may be billed to a business associated with the subscriber. Alternatively, a person other than the subscriber may be billed for one or more DNs. The payment method identifies a payment method selected by the subscriber or billed party. For example, monthly statement, automatic withdrawal, or credit card payment methods may be selected. Additional information may also be included in the billing arrangements section of each calling plan.

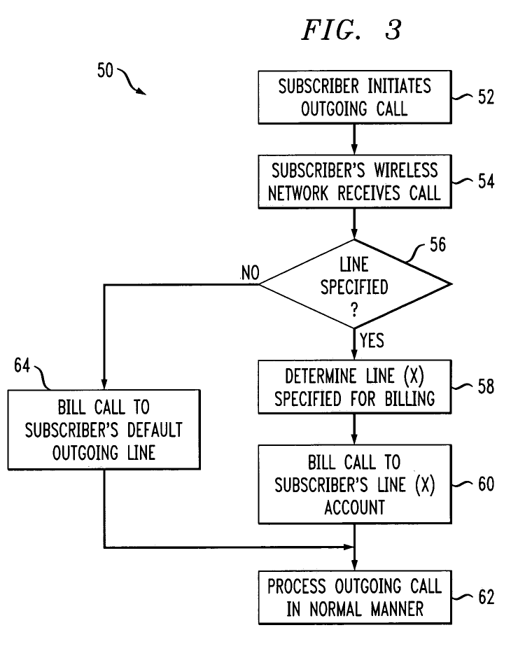

With reference to FIG. 3, a method 50 for processing an outgoing call from the multi-line mobile device begins at step 52 when the subscriber initiates the outgoing call. The subscriber or another user of the multi-line mobile device may specify which DN or line is to be billed for the outgoing call, for example, by activating a dedicated key, soft key, or a sequence of keys on the keypad in prior to dialing or otherwise specifying the DN for the outgoing call. Next, the subscriber's wireless network receives the outgoing call (step 54). At step 56, the subscriber's wireless network determines if a line was specified for billing in conjunction with subscriber charges associated with the outgoing call. If a line was specified for billing, the subscriber's wireless network determines which line (i.e., line (x)) was specified (step 58). At step 60, the subscriber's wireless network associates line (x) with the call and begins coordinating billing for the call to the subscriber's line (x) account. Next, the subscriber's wireless network continues processing the outgoing call in a normal manner (step 62).

In step 56, if the subscriber's wireless network determines a line was not specified for billing, the method advances to step 64 and the subscriber's wireless network associates a default outgoing line identified in the subscriber's calling plans associated with the multi-line mobile device with the call and begins coordinating billing for the call to the subscriber's account for the default outgoing line. Next, the subscriber's wireless network continues processing the outgoing call in a normal manner (step 62).

The various steps in the foregoing method 50 may be implemented by hardware, software, and/or combinations thereof within the wireless network 16 (FIG. 1), including one or more of the MSC 20 (FIG. 1), subscriber database 22 (FIG. 1), and billing center 47 (FIG. 1). More specifically, steps 54, 56, 58, 60, 62, and 64 may be implemented at least in part by hardware, software, and/or combinations thereof within the MSC 20 (FIG. 1). Steps 58, 60, 62, and 64 may be implemented at least in part by hardware, software, and/or combinations thereof within the subscriber database 22 (FIG. 1). Steps 60, 62, and 64 may be implemented at least in part by hardware, software, and/or combinations thereof within the billing center 47 (FIG. 1).

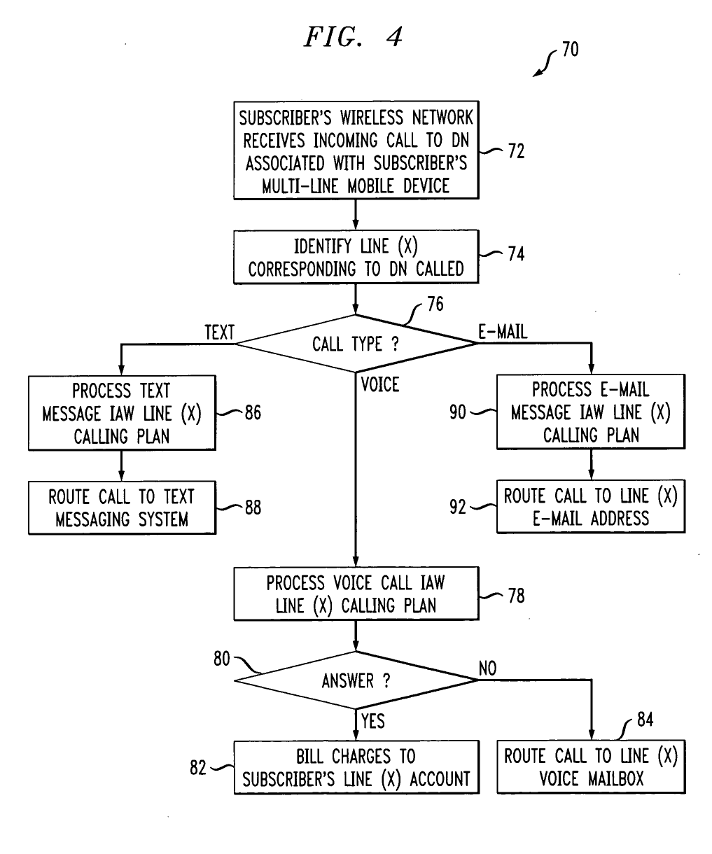

With reference to FIG. 4, a method 70 for processing an incoming call to a DN associated with the subscriber's multi-line mobile device begins at step 72 when the subscriber's wireless network receives the incoming call. Next, the subscriber's wireless network identifies which line (i.e., line (x)) corresponds to the DN called (step 74). At step 76, the subscriber's wireless network determines the call type for the incoming call. For example, the call may be a voice call or a data call. If the call is a data call, for example, it may be a text message or an e-mail message. At step 78, if the incoming call is a voice type, the subscriber's wireless network processes the voice call in accordance with the line (x) calling plan. Next, the subscriber's wireless network determines if the incoming call is answered (i.e., line (x) placed in an off-hook condition) (step 80). At step 82, the subscriber's wireless network begins coordinating billing for subscriber charges associated with the incoming call to the subscriber's line (x) account.

If the call is not answered at step 80, the method advances to step 84 and the subscriber's wireless network routes the incoming call to a line (x) voice mailbox associated with the subscriber. That is, if the subscriber has activated the voice mail feature in the line (x) calling plan.

If the call is a text message type at step 76, the method advances to step 86 and the subscriber's wireless network processes the text message in accordance with the line (x) calling plan. Next, the subscriber's wireless network routes the incoming call to the text messaging system where the subscriber's text message is stored in a line (x) text message storage area (step 88). That is, if the subscriber has activated the text messaging feature in the line (x) calling plan.

If the call is an e-mail message type at step 76, the method advances to step 90 and the subscriber's wireless network processes the e-mail message in accordance with the line (x) calling plan. Next, the subscriber's wireless network routes the incoming call to the e-mail system where the subscriber's e-mail message is stored in a line (x) e-mail message storage area (step 92). That is, if the subscriber has activated the e-mail feature in the line (x) calling plan.

The various steps in the foregoing method 70 may be implemented by hardware, software, and/or combinations thereof within the wireless network 16 (FIG. 1), including one or more of the MSC 20 (FIG. 1), subscriber database 22 (FIG. 1), voice mail system 26 (FIG. 1), text messaging system 28 (FIG. 1), e-mail system 30 (FIG. 1), and billing center 47 (FIG. 1). More specifically, steps 72, 74, 76, 78, 80, 82, 84, 86, 88, 90, and 92 may be implemented at least in part by hardware, software, and/or combinations thereof within the MSC 20 (FIG. 1). Steps 78, 82, 84, 86, 88, 90, and 92 may be implemented at least in part by hardware, software, and/or combinations thereof within the subscriber database 22 (FIG. 1). Step 84 may be implemented at least in part by hardware, software, and/or combinations thereof within the voice mail system 26 (FIG. 1). Step 88 may be implemented at least in part by hardware, software, and/or combinations thereof within the text messaging system 28 (FIG. 1). Step 92 may be implemented at least in part by hardware, software, and/or combinations thereof within the e-mail system 30 (FIG. 1). Step 82 may be implemented at least in part by hardware, software, and/or combinations thereof within the billing center 47 (FIG. 1).

While the invention is described herein in conjunction with exemplary embodiments, it is evident that many alternatives, modifications, and variations will be apparent to those skilled in the art. Accordingly, the embodiments of the invention in the preceding description are intended to be illustrative, rather than limiting, of the spirit and scope of the invention. More specifically, it is intended that the invention embrace all alternatives, modifications, and variations of the exemplary embodiments described herein that fall within the spirit and scope of the appended claims or the equivalents thereof.

1. A method for a wireless network to provide wireless service to each line of multiple lines associated with a multi-line mobile device, wherein a wireless service provider is associated with the wireless network and a subscriber is associated with the multi-line mobile device, the method including the steps:
a) assigning a unique directory number to each line, wherein each unique directory number of multiple unique directory number corresponds to one line of the multiple lines associated with the multi-line mobile device;
b) providing the subscriber with an independent calling plan for each line, wherein each independent calling plan of multiple independent calling plans corresponds to one unique directory number; and
c) configuring each independent calling plan to include information, values, and parameters that independently control call processing and billing functions for incoming calls and outgoing calls associated with the corresponding one unique directory numbers.

2. The method as set forth in claim 1, further including:
d) receiving an incoming call to a first unique directory number associated with the multi-line mobile device; and
e) processing the incoming call in accordance with a first independent calling plan associated with the multi-line mobile device, wherein the first independent calling plan corresponds to the first unique directory number.

3. The method as set forth in claim 1, further including:
d) receiving an outgoing call associated with a first unique directory number from the multi-line mobile device; and
e) processing the outgoing call in accordance with a first independent calling plan associated with the multi-line mobile device, wherein the first independent calling plan corresponds to the first unique directory number.

4. The method as set forth in claim 1 wherein each independent calling plan includes an identification information section, a rate plan section, a feature set section, and a billing arrangements section

5. The method as set forth in claim 4 wherein the identification information section of each independent calling plan includes at least one of corresponding directory number information and subscriber information.

6. The method as set forth in claim 4 wherein the rate plan section of each independent calling plan includes at least one of an amount of anytime minutes for the corresponding directory number, an amount of night and weekend minutes for the corresponding directory number, a flag identifying no variable charges for long distance calls associated with the corresponding directory number, and an amount of direct connect minutes for the corresponding directory number.

7. The method as set forth in claim 4 wherein the feature set section of each independent calling plan includes at least one of a variable ring tone flag for activation in conjunction with the corresponding directory number, a call waiting flag for activation in conjunction with the corresponding directory number, a call hold flag for activation in conjunction with the corresponding directory number, a three-way calling flag for activation in conjunction with the corresponding directory number, a call forwarding flag for activation in conjunction with the corresponding directory number, a caller ID flag for activation in conjunction with the corresponding directory number, a call restrictions flag for activation in conjunction with the corresponding directory number, a voice mail flag for activation in conjunction with the corresponding directory number, a text messaging flag for activation in conjunction with the corresponding directory number, a two-way messaging flag for activation in conjunction with the corresponding directory number, a wireless Web flag for activation in conjunction with the corresponding directory number, and an e-mail flag for activation in conjunction with the corresponding directory number.

8. The method as set forth in claim 7 wherein the text messaging flag is activated for at least two independent calling plans associated with the multi-line mobile device.

9. The method as set forth in claim 7 wherein the wireless Web flag is activated for at least two independent calling plans associated with the multi-line mobile device.

10. The method as set forth in claim 4 wherein the billing arrangements section of each independent calling plan includes at least one of a flag identifying the corresponding directory number as a default directory number for billing outgoing calls, a billed party associated with the corresponding directory number, a billed party address associated with the corresponding directory number, and a payment method associated with the corresponding directory number.

11. The method as set forth in claim 1 wherein the multiple lines associated with the multi-line mobile device include at least three lines.

12. A method for a wireless network to provide wireless service to a first line and a second line associated with a two-line mobile device, wherein a wireless service provider is associated with the wireless network and a subscriber is associated with the multi-line mobile device, the method including the steps:
a) assigning a first unique directory number to the first line and a second unique directory number to the second line;
b) providing the subscriber with a first independent calling plan for the first line and a second independent calling plan for the second line, wherein both the first and second independent calling plans include at least one of a text messaging flag for activation in conjunction with the corresponding directory number and a wireless Web flag for activation in conjunction with the corresponding directory number; and
c) configuring the first and second independent calling plan to include information, values, and parameters that independently control call processing and billing functions for incoming calls and outgoing calls associated with the corresponding first and second unique directory numbers, wherein at least one of the text messaging flag and the wireless Web flag are activated for both the first and second independent calling plans.

13. The method as set forth in claim 12, further including:
d) receiving a first incoming call to the first unique directory number associated with the multi-line mobile device;
e) determining a call type for the first incoming call is a text message type;
f) processing the first incoming call in accordance with the first independent calling plan associated with the multi-line mobile device, wherein the text messaging flag in the first independent calling plan is activated; and
g) routing the first incoming call to a text messaging system associated with the wireless network.

14. The method as set forth in claim 13, further including:
h) receiving a second incoming call to the second unique directory number associated with the multi-line mobile device;
i) determining a call type for the second incoming call is a text message type;
j) processing the second incoming call in accordance with the second independent calling plan associated with the multi-line mobile device, wherein the text messaging flag in the second independent calling plan is activated; and
k) routing the second incoming call to a text messaging system associated with the wireless network.

15. The method as set forth in claim 12, further including:
d) receiving an outgoing call from the multi-line mobile device;
e) determining if a billing line was specified in conjunction with placement of the outgoing call;
f) if a billing line was specified in conjunction with placement of the outgoing call, determining whether the first line or second line was specified as the billing line; and
g) coordinating billing of subscriber charges associated with the outgoing call to a predetermined party associated with billing for the billing line.

16. The method as set forth in claim 15, further including:
h) if a billing line was not specified in conjunction with placement of the outgoing call, determining if the first line was specified as a default billing line in the first independent calling plan; and
i) if the first line was specified as a default billing line in the first independent calling plan, coordinating billing of subscriber charges associated with the outgoing call to a first party associated with billing for the first line, otherwise coordinating billing of subscriber charges associated with the outgoing call to a second party associated with billing for the second line.

17. The method as set forth in claim 12, further including:
d) receiving an incoming call to the first unique directory number associated with the multi-line mobile device;
e) determining a call type for the incoming call is a voice type;
f) processing the incoming call in accordance with the first independent calling plan associated with the multi-line mobile device;
g) after the incoming call is answered, coordinating billing of subscriber charges associated with the incoming call to a billing party associated with the first line.

18. A wireless network providing wireless service to each line of multiple lines associated with a multi-line mobile device, wherein a wireless service provider is associated with the wireless network and a subscriber is associated with the multi-line mobile device, the wireless network including:
a mobile switching center for processing incoming and outgoing calls associated with each line of the multi-line mobile device, wherein each line of the multi-line mobile device is associated with a unique directory number; and
a subscriber database in communication with the mobile switching center and including an independent calling plan for each line of the multi-line mobile device, wherein each independent calling plan corresponds to a unique directory number, wherein at least two of the independent calling plans include at least one of a text messaging flag for activation in conjunction with the corresponding directory number and a wireless Web flag for activation in conjunction with the corresponding directory number, wherein at least one of the text messaging flag and the wireless Web flag are activated for at least two of the independent calling plans.

19. The wireless network as set forth in claim 18, further including:
a text messaging system in communication with the mobile switching center and including a text message storage area allocated for each line of the multi-line mobile device, wherein each allocated text message storage area corresponds to a unique directory number, wherein the text messaging flag is activated for at least two of the independent calling plans.

20. The wireless network as set forth in claim 18, further including:
an e-mail system in communication with the mobile switching center and including an e-mail message storage area allocated for each line of the multi-line mobile device, wherein each allocated e-mail message storage area corresponds to a unique directory number, wherein an e-mail flag is activated for at least one of the independent calling plans.
